(19) United States
(12) Patent Application Publication
(10) Pub. No.: US 2020/0067542 A1
(43) Pub. Date: Feb. 27, 2020

(54) RADIO FREQUENCY FRONT END MODULE AND RADIO FREQUENCY SIGNAL PROCESSING METHOD

(71) Applicant: SMARTER MICROELECTRONICS (GUANG ZHOU) CO., LTD., Guangzhou (CN)

(72) Inventors: Baiming XU, Guangzhou (CN); Qiang SU, Guangzhou (CN); Jiangtao YI, Guangzhou (CN); Ping LI, Guangzhou (CN)

(73) Assignee: SMARTER MICROELECTRONICS (GUANG ZHOU) CO., LTD., Guangzhou (CN)

(21) Appl. No.: 16/673,963

(22) Filed: Nov. 5, 2019

Related U.S. Application Data
(63) Continuation of application No. PCT/CN2017/113832, filed on Nov. 30, 2017.

(30) Foreign Application Priority Data
May 10, 2017 (CN) 201710327263.7

(51) Int. Cl. H04B 1/04

(52) U.S. Cl. CPC H04B 1/0458; H04B 2001/0408

(57) ABSTRACT

A radio frequency front end module includes an amplifier, a switch and a filter. The switch couples the amplifier with an antenna and connecting the amplifier with the filter, thereby forming a first signal channel in the radio frequency front end module, when a radio frequency signal needs to be transmitted and the transmitted radio frequency signal from a baseband chip needs to be filtered by the radio frequency front end module. The first signal channel can amplify and filter the radio frequency signal transmitted in the first signal channel. The switch can also couples the amplifier with the antenna, thereby forming a second signal channel in the radio frequency front end module, when the transmitted radio frequency signal does not need to be filtered by the radio frequency front end module. The second signal channel can amplify the radio frequency signal transmitted in the second signal channel.

### CROSS-REFERENCE TO RELATED APPLICATIONS

The present application is a continuation of International Application No. PCT/CN2017/113832 filed on Nov. 30, 2017, which claims priority to Chinese Patent Application No. 201710327263.7 filed on May 10, 2017. The disclosures of these applications are hereby incorporated by reference in their entirety.

### BACKGROUND

In the related art, a radio frequency front-end module (FEM) is a chip composed of a power amplifier and a multi-way switch. If a received multi-frequency mobile signal is a radio frequency signal which is to be filtered, a power amplifier and a filter in a frequency corresponding to the filtering band are connected with a transmitting/receiving switch of the FEM, which results in an increase in the area and volume of the entire FEM, and an increase in the number of chips, and high cost.

### SUMMARY

This disclosure relates generally to wireless communication technologies, and more specifically to a radio frequency front-end module and a method for processing a radio frequency signal.

A radio frequency front-end module and a method for processing a radio frequency signal are provided according to the embodiments of the disclosure. With the embodiments of the disclosure, normal reception or transmission of a mobile signal can be ensured, the area and volume of the FEM can be reduced, and manufacture cost is reduced.

To achieve the above objective, technical solutions according to the embodiments of the disclosure can be implemented as follows.

A radio frequency front-end module is provided according to an embodiment of the disclosure, which can include:

an amplifier, a switch and a filter.

The switch is configured to, in a case that a radio frequency signal is to be transmitted and the radio frequency signal transferred from a baseband chip is to be filtered by the radio frequency front-end module, connect the amplifier with an antenna, and connect the amplifier with the filter, so as to form a first signal path in the radio frequency front-end module. The first signal path is used for amplifying and filtering the radio frequency signal transferred in the first signal path.

The switch is further configured to, in a case that the transferred radio frequency signal is not to be filtered by the radio frequency front-end module, connect the amplifier with the antenna, so as to form a second signal path in the radio frequency front-end module. The second signal path is used for amplifying the radio frequency signal transferred in the second signal path.

A method for processing a radio frequency signal is further provided according to an embodiment of the disclosure, which includes:

in a case that a to-be-transmitted radio frequency signal transferred is to be filtered by a radio frequency front-end module, connecting an amplifier with an antenna through a switch, and connecting the amplifier with a filter through the switch, so as to form a first signal path in the radio frequency front-end module, and amplifying and filtering the to-be-transmitted radio frequency signal transferred based on the first signal path; and

in a case that the transferred radio frequency signal is not to be filtered by the radio frequency front-end module, connecting the amplifier with the antenna through the switch, so as to form a second signal path in the radio frequency front-end module, and amplifying the to-be-transmitted radio frequency signal transferred based on the second signal path.

### BRIEF DESCRIPTION OF THE DRAWINGS

FIG. 1 is a schematic diagram showing a composition structure of a radio frequency front-end module according to an embodiment of the disclosure.

FIG. 2 is a schematic diagram showing an implementation flow of a method for processing a radio frequency signal according to an embodiment of the disclosure.

FIG. 3 is a schematic diagram showing a composition structure of a radio frequency front-end module according to an embodiment of the disclosure.

FIG. 4 is a schematic diagram showing a composition structure of a radio frequency front-end module according to an embodiment of the disclosure.

FIG. 5 is a schematic diagram showing a composition structure of a radio frequency front-end module according to an embodiment of the disclosure.

FIG. 6 is a schematic diagram showing a composition structure of a radio frequency front-end module according to an embodiment of the disclosure.

FIG. 7 is a schematic diagram showing a composition structure of a radio frequency front-end module according to an embodiment of the disclosure.

FIG. 8 is a schematic diagram showing a composition structure of a radio frequency front-end module according to an embodiment of the disclosure.

### DETAILED DESCRIPTION

In order to make the features and technical contents of the embodiment of the disclosure be interpreted in detail, the implementation of the embodiment of the disclosure is described in detail below in conjunction with the accompanying drawings, and the accompanying drawings are merely used for illustrative purposes and are not intended to limit the disclosure.

In the description of the embodiment of the disclosure, it should be noted that, unless otherwise stated and limited, the term “connection” should be interpreted broadly. For example, the connection can be an electrical connection or internal communication between two components, and can be a direct connection or an indirect connection through an intermediate medium. The meaning of the above terms can be understood by those skilled in the art according to the specific situation.

It should be noted that the terms “first/second/third” involved in the embodiment of the disclosure is merely used for distinguishing similar objects, and does not represent an order of the objects. It should be appreciated that objects distinguished by “first/second/third” may be swapped in an order or sequence, where permitted. It should be appreciated that the objects distinguished by “first/second/third” may be interchanged under appropriate conditions, so that the embodiment of the disclosure described here can be implemented in a sequence other than a sequence graphically shown or described here.

Before detailed description of the disclosure, the nouns and terms involved in the embodiment of the disclosure are illustrated, and the nouns and terms involved in the embodiment of the disclosure are explained as follows.

1) A filter is configured to filter a radio frequency signal transferred in the radio frequency front-end terminal.

2) An amplifier is configured to amplify the radio frequency signal transferred in the radio frequency front-end terminal.

3) A duplexer is a device for separating two signals, that is, a transmitted signal and a received signal from each other, to ensure that both the receiving and transmitting can be normally performed simultaneously. The duplexer is composed of two band-stop filters with different frequencies to avoid a signal transmitted by the local machine from being transmitted to a receiver. The duplexer is composed of two (transmission/reception) combined filters which share a common node (antenna), allowing the device to transmit (Tx) and receive (Rx) simultaneously. The duplexer is commonly used in frequency division duplex (FDD) radio applications in which one filter is a transmission filter and the other is a reception filter. The duplexer is designed to ensure that the passband of one filter does not load the other filter.

4) A multiplexer has a single input port and multiple output ports. The multiplexer is a set of non-superimposed filters, which do not load each other in a combination mode, and have highly-isolated outputs. The multiplexer is composed of multiple combined (transmission/reception) filters which share a common node (antenna), allowing the device to transmit (Tx) and receive (Rx) simultaneously.

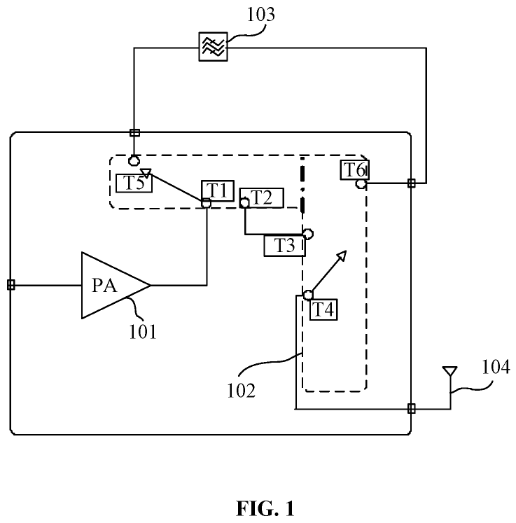

FIG. 1 is a schematic diagram showing a composition structure of a radio frequency front-end module according to an embodiment of the disclosure. As shown in FIG. 1, the composition structure of the radio frequency front-end module according to an embodiment of the disclosure includes: an amplifier 101, a switch 102 and a filter 103. In FIG. 1, a connection of the radio frequency module and an antenna 104 is shown.

The various device components, units, blocks, or portions may have modular configurations, or are composed of discrete components, but nonetheless can be referred to as “modules” in general. In other words, the “components,” “modules” or “units” referred to herein may or may not be in modular forms.

The switch 102 is configured to, in a case that a transferred radio frequency signal is to be filtered by the radio frequency front-end module, connect the amplifier 101 with the antenna 104, and connect the amplifier 101 with the filter 103, so as to form a first signal path in the radio frequency front-end module. The first signal path is used for amplifying and filtering the transferred radio frequency signal.

The switch 102 is further configured to, in a case that the transferred radio frequency signal is not to be filtered by the radio frequency front-end module, connect the amplifier 101 with the antenna 104, so as to form a second signal path in the radio frequency front-end module, The second signal path is used for amplifying the transferred radio frequency signal.

In some embodiments, in the process of amplifying a to-be-transmitted radio frequency signal, in a case that the to-be-transmitted radio frequency signal is to be filtered, the amplifier 101 in the first signal path is configured to: amplify the to-be-transmitted radio frequency signal; and send the amplified to-be-transmitted radio frequency signal to the filter 103 in the first signal path.

The filter 103 in the first signal path is configured to: filter the amplified to-be-transmitted radio frequency signal; send the filtered to-be-transmitted radio frequency signal to the antenna 104; and transmit the to-be-transmitted radio frequency signal through the antenna 104.

In some embodiments, a first end of the amplifier 101 is connected to a first connection end of the switch 102.

A second connection end of the switch 102 is connected to a third connection end of the switch 102.

A fourth connection end of the switch 102 is connected to a first end of the antenna 104.

A first end of the filter 103 is connected to a fifth connection end of the switch 102, and a second end of the filter 103 is connected to a sixth connection end of the switch 102. The connection ends are connected or disconnected by the switch.

In some embodiments, the switch can be connected under control of a high-level signal or can be disconnected under control of a low-level signal.

A second end of the amplifier 101 receives a radio frequency signal.

The radio frequency signal includes, but is not limited to, 2G, 3G, 4G, and 5G signals.

The amplifier 101 in the second signal path is configured to amplify the to-be-transmitted radio frequency signal, send the amplified to-be-transmitted radio frequency signal to the antenna 104, and transmit the to-be-transmitted radio frequency signal through the antenna 104.

In the process of amplifying the to-be-transmitted radio frequency signal, in a case that the to-be-transmitted radio frequency signal is not to be filtered, the amplifier 101 in the second signal path is configured to: amplify the to-be-transmitted radio frequency signal, send the amplified to-be-transmitted radio frequency signal to the antenna 104, and transmit the to-be-transmitted radio frequency signal through the antenna 104.

It should be noted that the first end of the amplifier 101 is connected to the first connection end of the switch 102 (the first connection end and connection ends mentioned hereinafter are not shown in the drawings, but positions of the connection ends in the drawings can be known according to a connection relationship with related modules hereinafter).

A second connection end of the switch 102 is connected to a third connection end of the switch 102.

A fourth connection end of the switch 102 is connected to a first end of the antenna 104.

The ends are connected or disconnected by the switch.

A second end of the amplifier 101 receives a radio frequency signal.

The radio frequency signal includes, but is not limited to, 2G, 3G, 4G, and 5G signals.

In some embodiments, in a case that there are multiple filters corresponding to different frequency bands and at least one of the filters is in an operation state, the filters in the operation state filter, in frequency bands corresponding to the filters, to-be-transmitted radio frequency signals in respective frequency bands by switching of the switch.

The switch 102 is further configured to, in a case that the to-be-transmitted radio frequency signal transferred is to be filtered by the radio frequency front-end module, connect the amplifier 101 with the antenna 104, and based on a target communication frequency band, connect the filter in a frequency band corresponding to the target communication frequency band with the amplifier 101, so as to form the first signal path for the target communication frequency band in the radio frequency front-end module. The first signal path is used for amplifying and filtering the to-be-transmitted radio frequency signal transferred in the target communication frequency band.

The switch 102 is further configured to, in a case that the transferred radio frequency signal is not to be filtered by the radio frequency front-end module, connect the amplifier 101 with the antenna 104, so as to form a second signal path for the target communication frequency band in the radio frequency front-end module. The second signal path is used for amplifying the transferred radio frequency signal in the target communication frequency band.

In some embodiments, the switch 102 includes a first sub-switch and a second sub-switch (the sub-switch is not shown in FIG. 1 and subsequent drawings, but it is easy to understand the drawings based on the description for a connection relationship between the sub-switch and other modules).

A first end of the first sub-switch is connected to the first end of the amplifier 101, and a first end of the second sub-switch is connected to the first end of the antenna 104.

The first sub-switch is configured to, in a case that the transferred radio frequency signal is to be filtered by the radio frequency front-end module, connect a second end of the first sub-switch with the first end of the filter corresponding to the target communication frequency band.

The second sub-switch is configured to, in a case that the transferred radio frequency signal is to be filtered by the radio frequency front-end module, connect a second end of the second sub-switch with the second end of the filter corresponding to the target communication frequency band, so as to form the first signal path corresponding to the target communication frequency band in the radio frequency front-end module.

The first sub-switch is configured to, in a case that the transferred radio frequency signal is not to be filtered by the radio frequency front-end module, connect a second end of the first sub-switch with a second end of the second sub-switch, so as to form the second signal path for directly connecting the amplifier 101 with the antenna 104 in the radio frequency front-end module.

In some embodiments, a connection relationship between the first sub-switch and the second sub-switch can be changed in response to a control instruction transmitted by a controller to the switch 104. The control instruction includes but is not limited to a high-level signal and a low-level signal. The controller can be provided inside the radio frequency front-end module, or can be implemented by a baseband chip in a base station or a terminal.

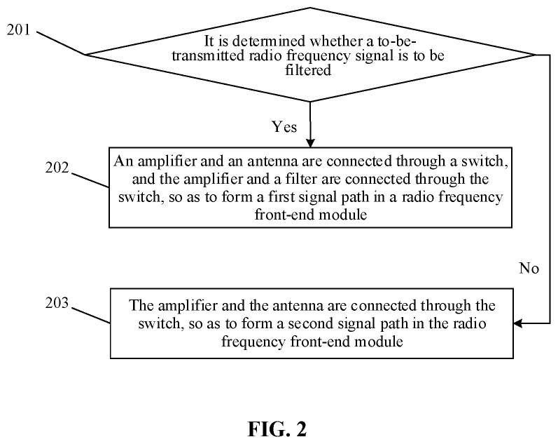

FIG. 2 is a schematic diagram showing an implementation flow of a method for processing a radio frequency signal according to an embodiment of the disclosure. As shown in FIG. 2, the implementation flow of the method for processing a radio frequency signal according to an embodiment of the disclosure includes steps 201 to 203 as follows.

At step 201, it is determined whether a to-be-transmitted radio frequency signal is to be filtered, the method proceeds to step 202 in a case that the to-be-transmitted radio frequency signal is to be filtered, and the method proceeds to step 203 in a case that the to-be-transmitted radio frequency signal is not to be filtered.

At step 202, an amplifier is connected with an antenna through a switch, and the amplifier is connected with a filter through the switch, so as to form a first signal path in a radio frequency front-end module.

At step 203, the amplifier is connected with the antenna through the switch, so as to form a second signal path in the radio frequency front-end module.

In some embodiments, with the structure shown in FIG. 1, the transferred radio frequency signal is amplified and filtered based on the first signal path, which is implemented by operations as follows.

When a to-be-transmitted signal is processed, the amplifier in the first signal path amplifies the to-be-transmitted radio frequency signal, and sends the amplified to-be-transmitted radio frequency signal to the filter in the first signal path.

The filter in the first signal path filters the amplified to-be-transmitted radio frequency signal, sends the filtered to-be-transmitted radio frequency signal to the antenna, and transmits the to-be-transmitted radio frequency signal through the antenna.

In some embodiments, the transferred radio frequency signal is only amplified based on the second signal path, which is implemented by operations as follows.

The amplifier in the second signal path amplifies the to-be-transmitted radio frequency signal, sends the amplified to-be-transmitted radio frequency signal to the antenna, and transmits the to-be-transmitted radio frequency signal through the antenna.

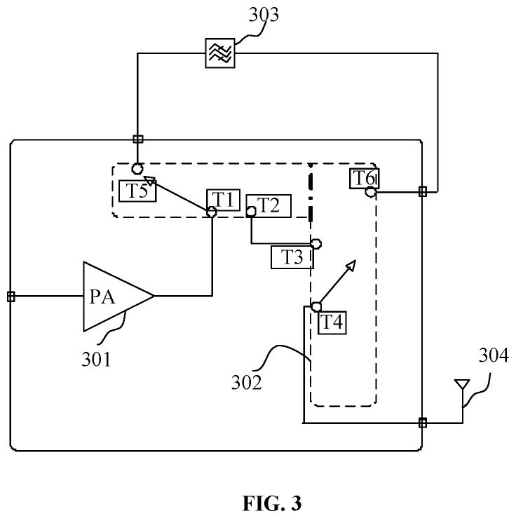

FIG. 3 is a schematic diagram showing a composition structure of a radio frequency front-end module according to an embodiment of the disclosure. With the structure shown in FIG. 3, any one to-be-transmitted signal of a 2G signal, a 3G signal, a 4G signal and a 5G signal can be processed. As shown in FIG. 3, the composition structure of the radio frequency front-end module according to an embodiment of the disclosure includes an amplifier 301, a switch 302 and a filter 303.

In FIG. 3, a connection of the radio frequency module and an antenna 304 is also shown.

The switch 302 is configured to, in a case that a transferred radio frequency signal is to be filtered, connect the amplifier 301 with the antenna 304, and connect the amplifier 301 with the filter 303, so as to form a first signal path in the radio frequency front-end module. The first signal path is used for amplifying and filtering the to-be-transmitted radio frequency signal.

The switch 302 is further configured to, in a case that the transferred radio frequency signal is not to be filtered, connect the amplifier 301 with the antenna 304, so as to form a second signal path in the radio frequency front-end module. The second signal path is used for amplifying the to-be-transmitted radio frequency signal.

In practical applications, in the process of amplifying the to-be-transmitted radio frequency signal, in a case that the to-be-transmitted radio frequency signal is to be filtered, the amplifier 301 in the first signal path is configured to: amplify the to-be-transmitted radio frequency signal; and send the amplified to-be-transmitted radio frequency signal to the filter 303 in the first signal path.

The filter 303 in the first signal path is configured to: filter the amplified to-be-transmitted radio frequency signal; send the filtered to-be-transmitted radio frequency signal to the antenna 304; and transmit the to-be-transmitted radio frequency signal through the antenna 304.

In some embodiments, a first end of the amplifier 301 is connected to a first connection end of the switch 302.

A second connection end of the switch 302 is connected to a third connection end of the switch 302.

A fourth connection end of the switch 302 is connected to a first end of the antenna 304.

A first end of the filter 303 is connected to a fifth connection end of the switch 302, and a second end of the filter 303 is connected to a sixth connection end of the switch 302. The connection ends are connected or disconnected by the switch.

In some embodiments, the switch can be connected in response to a received high-level control signal, or can be disconnected in response to a received low-level control signal.

A second end of the amplifier 301 receives a radio frequency signal.

The radio frequency signal includes, but is not limited to, 2G, 3G, 4G, and 5G signals.

The amplifier 301 in the second signal path is configured to: amplify the to-be-transmitted radio frequency signal, send the amplified to-be-transmitted radio frequency signal to the antenna 304, and transmit the to-be-transmitted radio frequency signal through the antenna 304.

In the process of amplifying the to-be-transmitted radio frequency signal, in a case that the to-be-transmitted radio frequency signal is not to be filtered, the amplifier 301 in the second signal path is configured to: amplify the to-be-transmitted radio frequency signal, send the amplified to-be-transmitted radio frequency signal to the antenna 304, and transmit the to-be-transmitted radio frequency signal through the antenna 304.

In some embodiments, the first end of the amplifier 301 is connected to the first connection end of the switch 302.

The second connection end of the switch 302 is connected to the third connection end of the switch 302.

The fourth connection end of the switch 302 is connected to the first end of the antenna 304.

The connection ends are connected or disconnected by the switch.

A second end of the amplifier 301 receives a radio frequency signal.

The radio frequency signal includes, but is not limited to, 2G, 3G, 4G, and 5G radio frequency signals.

In practical applications, in a case that there are multiple filters corresponding to different frequency bands and at least one of the filters is in an operation state, the filters in the operation state filter, in frequency bands corresponding to the filters, to-be-transmitted radio frequency signals in respective frequency bands by switching of the switch.

The switch 302 is further configured to, in a case that the transferred radio frequency signal is to be filtered by the radio frequency front-end module, connect the amplifier 301 with the antenna 304, and based on a target communication frequency band, connect the filter in a frequency band corresponding to the target communication frequency band with the amplifier 301, so as to form the first signal path for the target communication frequency band in the radio frequency front-end module. The first signal path is used for amplifying and filtering the transferred radio frequency signal in the target communication frequency band.

The switch 302 is further configured to connect, in a case that the transferred radio frequency signal is not to be filtered by the radio frequency front-end module, connect the amplifier 301 with the antenna 304, so as to form a second signal path for the target communication frequency band in the radio frequency front-end module. The second signal path is used for amplifying the transferred radio frequency signal in the target communication frequency band.

In practical applications, the switch 302 includes a first sub-switch and a second sub-switch.

The first sub-switch and the second sub-switch can be implemented by first and second.

A first end of the first sub-switch is connected to the first end of the amplifier 301, and a first end of the second sub-switch is connected to the first end of the antenna 304.

The first sub-switch is configured to, in a case that the transferred radio frequency signal is to be filtered by the radio frequency front-end module, connect a second end of the first sub-switch with the first end of the filter corresponding to the target communication frequency band.

The second sub-switch is configured to, in a case that the transferred radio frequency signal is to be filtered by the radio frequency front-end module, connect a second end of the second sub-switch with the second end of the filter corresponding to the target communication frequency band, so as to form the first signal path corresponding to the target communication frequency band in the radio frequency front-end module.

The first sub-switch is configured to, in a case that the transferred radio frequency signal is not to be filtered, connect a second end of the first sub-switch with a second end of the second sub-switch, so as to form the second signal path for directly connecting the amplifier 301 with the antenna 304 in the radio frequency front-end module.

In practical applications, a connection relationship between the first sub-switch and the second sub-switch can be changed in response to a control instruction transmitted by a controller to the switch 304. The control instruction includes but is not limited to a high-level signal and a low-level signal. The controller can be provided inside the radio frequency front-end module or can be implemented by a baseband chip in a base station or a terminal.

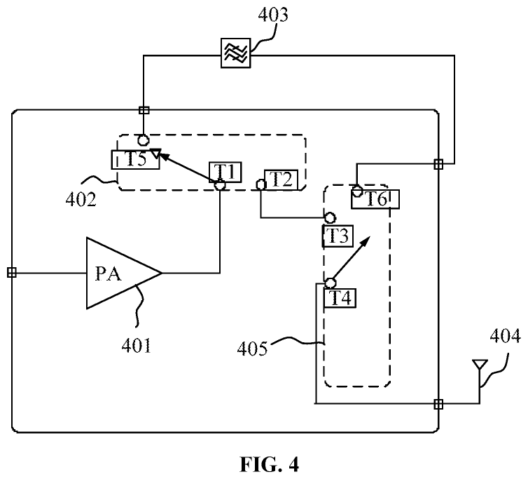

FIG. 4 is a schematic diagram showing a composition structure of a radio frequency front-end module according to an embodiment of the disclosure. With the structure shown in FIG. 4, any one to-be-transmitted signal of a 2G signal, a 3G signal, a 4G signal and a 5G signal can be processed. As shown in FIG. 4, the composition structure of the radio frequency front-end module according to an embodiment of the disclosure includes an amplifier 401, a first switch 402, a second switch 405 and a filter 403.

In FIG. 4, a connection of the radio frequency module and an antenna 404 is also shown.

A difference from the radio frequency front-end module shown in the previous embodiment is only in that the first switch 402 and the second switch 405 in the present embodiment are respectively implemented by two single-pole multi-throw switches. The switch 302 in the radio frequency front-end terminal in the embodiment is a double-pole multi-throw switch. Therefore, the function and processing of each component in the embodiment are not described again.

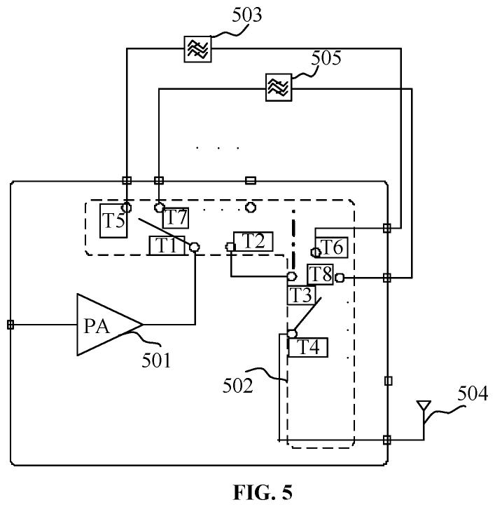

The composition structure of the radio frequency front-end module in the embodiment of the disclosure is as shown in FIG. 5. With the structure, all of 2G, 3G, 4G, 5G and other communication modes can be supported. The composition structure of the radio frequency front-end module according to an embodiment of the disclosure includes an amplifier 501, a switch 502, a first filter 503 and a second filter 505.

In FIG. 5, a connection of the radio frequency module and an antenna 504 is also shown.

The first filter 503 and the second filter 505 are respectively configured to filter, in respective frequency bands, to-be-transmitted radio frequency signals to be filtered.

The radio frequency signal includes, but is not limited to, 2G, 3G, 4G, and 5G signals.

The first filter 503 and the second filter 505 can be combined based on a frequency of a to-be-processed signal, to form different formats.

The switch 502 is configured to, in a case that a transferred radio frequency signal is to be filtered, connect the amplifier 501 with the antenna 504, and connect the amplifier 501 with the first filter 503 or connect the amplifier 501 with the second filter 505, so as to form a first signal path in the radio frequency front-end module. The first signal path is used for amplifying and filtering the transferred radio frequency signal.

The switch 502 is further configured to, in a case that the transferred radio frequency signal is not to be filtered, connect the amplifier 501 with the antenna 504, so as to form a second signal path in the radio frequency front-end module. The second signal path is used for amplifying the transferred radio frequency signal.

In practical applications, in the process of amplifying a to-be-transmitted radio frequency signal, in a case that the to-be-transmitted radio frequency signal is to be filtered, the amplifier 501 in the first signal path is configured to: amplify a to-be-transmitted 2G or 3G signal; and send the amplified to-be-transmitted radio frequency signal to the first filter 503 in the first signal path, or send the amplified to-be-transmitted radio frequency signal to the second filter 505 in the first signal path.

The first filter 503 in the first signal path is configured to: filter the amplified to-be-transmitted radio frequency signal; send the filtered to-be-transmitted radio frequency signal to the antenna 504; and transmit the to-be-transmitted radio frequency signal through the antenna 504.

The second filter 505 in the first signal path is configured to: filter the amplified to-be-transmitted radio frequency signal; send the filtered to-be-transmitted radio frequency signal to the antenna 504; and transmit the to-be-transmitted radio frequency signal through the antenna 504.

In some embodiments, a first end of the amplifier 501 is connected to a first connection end of the switch 502.

A second connection end of the switch 502 is connected to a third connection end of the switch 502.

A fourth connection end of the switch 502 is connected to a first end of the antenna 504.

A first end of the first filter 503 is connected to a fifth connection end of the switch 502, and a second end of the first filter 503 is connected to a sixth connection end of the switch 502.

A first end of the second filter 505 is connected to a seventh connection end of the switch 502, and a second end of the second filter 505 is connected to an eighth connection end of the switch 502.

The connection ends are connected or disconnected by the switch.

The amplifier 501 in the second signal path is configured to: amplify the to-be-transmitted radio frequency signal, send the amplified to-be-transmitted radio frequency signal to the antenna 504, and transmit the to-be-transmitted radio frequency signal through the antenna 504.

In the process of amplifying the to-be-transmitted radio frequency signal, in a case that the to-be-transmitted radio frequency signal is not to be filtered, the amplifier 501 in the second signal path is configured to: amplify the to-be-transmitted radio frequency signal, send the amplified to-be-transmitted radio frequency signal to the antenna 504, and transmit the to-be-transmitted radio frequency signal through the antenna 504.

In some embodiments, a first end of the amplifier 501 is connected to a first connection end of the switch 502.

A second connection end of the switch 502 is connected to a third connection end of the switch 502.

A fourth connection end of the switch 502 is connected to a first end of the antenna 504.

The connection ends are connected or disconnected by the switch.

In practical applications, the switch 502 includes a first sub-switch and a second sub-switch.

A first end of the first sub-switch is connected to the first end of the amplifier 501, and a first end of the second sub-switch is connected to the first end of the antenna 504.

The first sub-switch is configured to, in a case that the transferred radio frequency signal is to be filtered by the radio frequency front-end module, connect a second end of the first sub-switch with the first end of the filter corresponding to the target communication frequency band.

The second sub-switch is configured to, in a case that the transferred radio frequency signal is to be filtered by the radio frequency front-end module, connect a second end of the second sub-switch with the second end of the filter corresponding to the target communication frequency band, so as to form the first signal path corresponding to the target communication frequency band in the radio frequency front-end module.

The first sub-switch is configured to, in a case that the transferred radio frequency signal is not to be filtered by the radio frequency front-end module, connect a second end of the first sub-switch with a second end of the second sub-switch, so as to form the second signal path for directly connecting the amplifier 501 with the antenna 504 in the radio frequency front-end module.

In practical applications, a connection relationship between the first sub-switch and the second sub-switch can be changed in response to a control instruction transmitted by a controller to the switch 504. The control instruction includes but not limited to a high-level signal and a low-level signal. The controller can be provided inside the radio frequency front-end module or can be implemented by a baseband chip in a base station or a terminal.

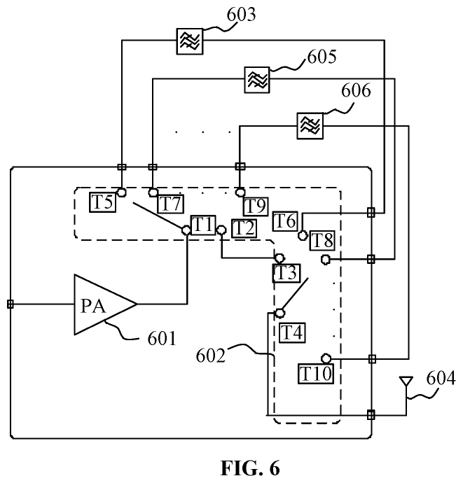

The composition structure of the radio frequency front-end module in the embodiment of the disclosure is as shown in FIG. 6. With the structure, all of 2G, 3G, 4G, 5G and other communication mode can be supported. The composition structure of the radio frequency front-end module according to an embodiment of the disclosure includes an amplifier 601, a switch 602, a first filter 603, a second filter 605 and a third filter 606. In FIG. 6, a connection of the radio frequency module and an antenna 604 is also shown.

The first filter 603, the second filter 605 and the third filter 606 are respectively configured to filter, in respective frequency bands, radio frequency signals which are to be filtered.

The radio frequency signal includes, but is not limited to, 2G, 3G, 4G, and 5G signals.

The first filter 603, the second filter 605 and the third filter 606 can be combined according to a frequency of a to-be-processed signal, to form different formats.

The switch 602 is configured to, in a case that a transferred radio frequency signal is to be filtered, connect the amplifier 601 with the antenna 604, and connect the amplifier 601 with the first filter 603 or connect the amplifier 601 with the second filter 605 or connect the amplifier 601 with the third filter 606, so as to form a first signal path in the radio frequency front-end module. The first signal path is used for amplifying and filtering a transferred 2G, 3G or 4G signal.

The switch 602 is further configured to, in a case that the transferred 2G, 3G or 4G signal is not to be filtered, connect the amplifier 601 with the antenna 604, so as to form a second signal path in the radio frequency front-end module, The second signal path is used for amplifying the transferred radio frequency signal.

In some implementations, in the process of amplifying the to-be-transmitted 2G, 3G or 4G signal, in a case that the to-be-transmitted 2G, 3G or 4G signal is to be filtered, the amplifier 601 in the first signal path is configured to: amplify the to-be-transmitted 2G, 3G or 4G signal; and send the amplified to-be-transmitted 2G signal to the first filter 603 in the first signal path, or send the amplified to-be-transmitted 3G signal to the second filter 605 in the first signal path, or send the amplified to-be-transmitted 4G signal to the third filter 606 in the first signal path.

The first filter 603 in the first signal path is configured to: filter the amplified to-be-transmitted radio frequency signal, the radio frequency signal including but not limited to 2G signals in different frequencies; send the filtered to-be-transmitted radio frequency signal to the antenna 604; and transmit the to-be-transmitted radio frequency signal through the antenna 604.

The second filter 605 in the first signal path is configured to: filter the amplified to-be-transmitted radio frequency signal, the radio frequency signal including but not limited to 3G signals in different frequencies; send the filtered to-be-transmitted radio frequency signal to the antenna 604; and transmit the to-be-transmitted radio frequency signal through the antenna 604.

The third filter 606 in the first signal path is configured to: filter the amplified to-be-transmitted radio frequency signal, the radio frequency signal including but not limited to 4G signals in different frequencies; send the filtered to-be-transmitted radio frequency signal to the antenna 604; and transmit the to-be-transmitted radio frequency signal through the antenna 604,

In some embodiments, a first end of the amplifier 601 is connected to a first connection end of the switch 602.

A second connection end of the switch 602 is connected to a third connection end of the switch 602.

A fourth connection end of the switch 602 is connected to a first end of the antenna 604.

A first end of the first filter 603 is connected to a fifth connection end of the switch 602, and a second end of the first filter 603 is connected to a sixth connection end of the switch 602.

A first end of the second filter 605 is connected to a seventh connection end of the switch 602, and a second end of the second filter 605 is connected to an eighth connection end of the switch 602.

A first end of the third filter 606 is connected to a ninth connection end of the switch 602, and a second end of the third filter 606 is connected to a tenth connection end of the switch 602.

The connection ends are connected or disconnected by the switch.

The amplifier 601 in the second signal path is configured to: amplify the to-be-transmitted 2G, 3G or 4G signal, send the amplified to-be-transmitted radio frequency signal to the antenna 604, and transmit the to-be-transmitted 2G, 3G or 4G signal through the antenna 604.

In the process of amplifying the to-be-transmitted 2G, 3G or 4G signal, in a case that the to-be-transmitted 2G, 3G or 4G signal is not to be filtered, the amplifier 601 in the second signal path is configured to: amplify the to-be-transmitted 2G, 3G or 4G signal, send the amplified to-be-transmitted 2G, 3G or 4G signal to the antenna 604, and transmit the to-be-transmitted 2G, 3G or 4G signal through the antenna 604.

In some embodiments, a first end of the amplifier 601 is connected to a first connection end of the switch 602.

A second connection end of the switch 602 is connected to a third connection end of the switch 602.

A fourth connection end of the switch 602 is connected to a first end of the antenna 604.

The connection ends are connected or disconnected by the switch.

In practical applications, the switch 602 includes a first sub-switch and a second sub-switch.

A first end of the first sub-switch is connected to the first end of the amplifier 601, and a first end of the second sub-switch is connected to the first end of the antenna 604.

The first sub-switch is configured to, in a case that the transferred 2G, 3G or 4G signal is to be filtered by the radio frequency front-end module, connect a second end of the first sub-switch with the first end of the filter corresponding to the target communication frequency band.

The second sub-switch is configured to, in a case that the transferred radio frequency signal is to be filtered by the radio frequency front-end module, connect a second end of the second sub-switch with the second end of the filter corresponding to the target communication frequency band, so as to form the first signal path corresponding to the target communication frequency band in the radio frequency front-end module.

The first sub-switch is configured to, in a case that the transferred 2G, 3G or 4G signal is not to be filtered by the radio frequency front-end module, connect a second end of the first sub-switch with a second end of the second sub-switch, so as to form the second signal path for directly connecting the amplifier 601 with the antenna 604 in the radio frequency front-end module.

In practical applications, a connection relationship between the first sub-switch and the second sub-switch can be changed in response to a control instruction transmitted by a controller to the switch 604. The control instruction includes but is not limited to a high-level signal and a low-level signal. The controller can be provided inside the radio frequency front-end module, or can be implemented by a baseband chip in a base station or a terminal.

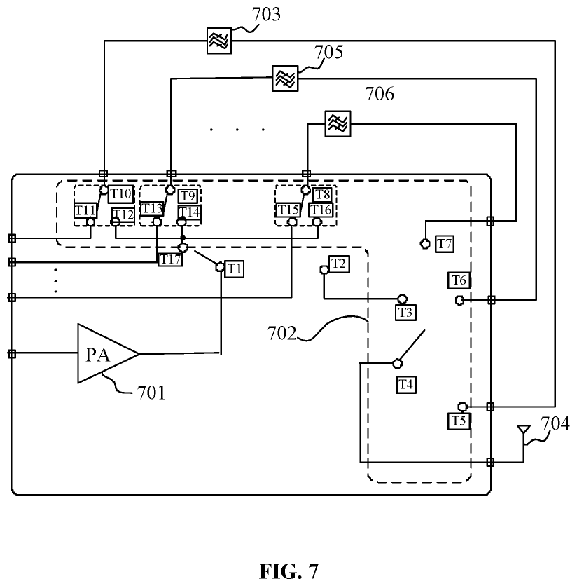

The composition structure of the radio frequency front-end module in the embodiment of the disclosure is as shown in FIG. 7. With the structure, all of 2G, 3G, 4G, and 5G and other communication modes can be supported. The composition structure of the radio frequency front-end module according to an embodiment of the disclosure includes an amplifier 701, a switch 702, a first filter 703, a second filter 705 and a third filter 706.

In FIG. 7, a connection of the radio frequency module and an antenna 704 is also shown.

The first filter 703, the second filter 705 and the third filter 706 are respectively configured to filter, in respective frequency bands, radio frequency signals which are to be filtered.

The radio frequency signal includes, but is not limited to, 2G, 3G, 4G, and 5G signals in different frequencies.

The first filter 703, the second filter 705 and the third filter 706 can be combined according to a frequency of a to-be-processed signal, to obtain different formats.

The switch 702 is configured to, in a case that a radio frequency signal received by the antenna 704 is to be filtered, connect the first filter 703 with a baseband chip or connect the second filter 705 with the baseband chip or connect the third filter 706 with the baseband chip, so as to form a third signal path in the radio frequency front-end module. The third signal path is used for filtering the 2G, 3G or 4G signal received by the antenna 704, and sending the filtered radio frequency signal to the baseband chip.

The switch 702 is further configured to, in a case that the 2G, 3G or 4G signal received by the antenna 704 is not to be filtered, connect the baseband chip with the antenna 704, so as to form a fourth signal path in the radio frequency front-end module. The fourth signal path is used for transmitting the radio frequency signal received by the antenna 704 to the baseband chip.

The first filter 703 in the third signal path is configured to: filter a radio frequency signal received by the antenna 704 which is to be filtered, where the radio frequency signal includes but is not limited to 2G signals in different frequencies; send the filtered radio frequency signal to the baseband chip.

The second filter 705 in the third signal path is configured to: filter a radio frequency signal received by the antenna 704 which is to be filtered, where the radio frequency signal includes but is not limited to 3G signals in different frequencies; send the filtered radio frequency signal to the baseband chip.

The third filter 706 in the third signal path is configured to: filter a radio frequency signal received by the antenna 704 which is to be filtered, where the radio frequency signal includes but is not limited to 4G signals in different frequencies; send the filtered radio frequency signal to the baseband chip.

In some embodiments, the baseband chip is connected to a first connection end of the switch 702.

A second connection end of the switch 702 is connected to a third connection end of the switch 702.

A fourth connection end of the switch 702 is connected to a first end of the antenna 704.

A first end of the first filter 703 is connected to a tenth connection end of the switch 702, and a second end of the first filter 703 is connected to a fifth connection end of the switch 702.

A first end of the second filter 705 is connected to a ninth connection end of the switch 702, and a second end of the second filter 705 is connected to a sixth connection end of the switch 702.

A first end of the third filter 706 is connected to an eighth connection end of the switch 702, and a second end of the third filter 706 is connected to a seventh connection end of the switch 702.

The connection ends are connected or disconnected by the switch.

In practical applications, the switch 702 includes a first sub-switch and a second sub-switch.

The first sub-switch further includes an eleventh connection end, a twelfth connection end, a thirteenth connection end, a fourteenth connection end, a fifteenth connection end, a sixteenth connection end, and a seventeenth connection end.

In a case that the third signal path is formed, the baseband chip is connected to the eleventh connection end, and the eleventh connection end is connected to the tenth connection end. The first filter 703 transmits the filtered radio frequency signal to the baseband chip through the tenth connection end and the eleventh connection end.

In a case that the third signal path is formed, the baseband chip is connected to the thirteenth connection end, and the thirteenth connection end is connected to the ninth connection end. The second filter 705 transmits the filtered radio frequency signal to the baseband chip through the ninth connection end and the thirteenth connection end.

In a case that the third signal path is formed, the baseband chip is connected to the fifteenth connection end, and the fifteenth connection end is connected to the eighth connection end. The first filter 703 transmits the filtered radio frequency signal to the baseband chip through the eighth connection end and the fifteenth connection end.

In a case that the fourth signal path is formed, the baseband chip is connected to the first connection end, the first connection end is connected to the second connection end, the second connection end is connected to the third connection end, and the third connection end is connected to the fourth connection end. The radio frequency signal received by the antenna 704 which is not to be filtered is transmitted to the baseband chip through the fourth signal path.

In some implementations, with the structure described in FIG. 7, the to-be-transmitted radio frequency signal which is to be filtered can also be transferred to the antenna 704, and then is transmitted through the antenna 704.

In some embodiments, the amplifier 701 is connected to the first connection end of the switch 702. The first connection end is connected to the seventeenth connection end. The seventeenth connection end is connected to the twelfth connection end, the fourteenth connection end and the sixteenth connection end. The twelfth connection end is connected to the tenth connection end, the fourteenth connection end is connected to the ninth connection end, and the sixteenth connection end is connected to the eighth connection end. According to the type of to-be-transmitted radio frequency signal, the to-be-transmitted radio frequency signal can be transferred to the first filter 703 through the twelfth connection end and the tenth connection end, or transferred to the second filter 705 through the fourteenth connection end and the ninth connection end, or transferred to the third filter 706 through the sixteenth connection end and the eighth connection end, to be filtered by the filters. Then the filtered radio frequency signal is transmitted through the antenna 704.

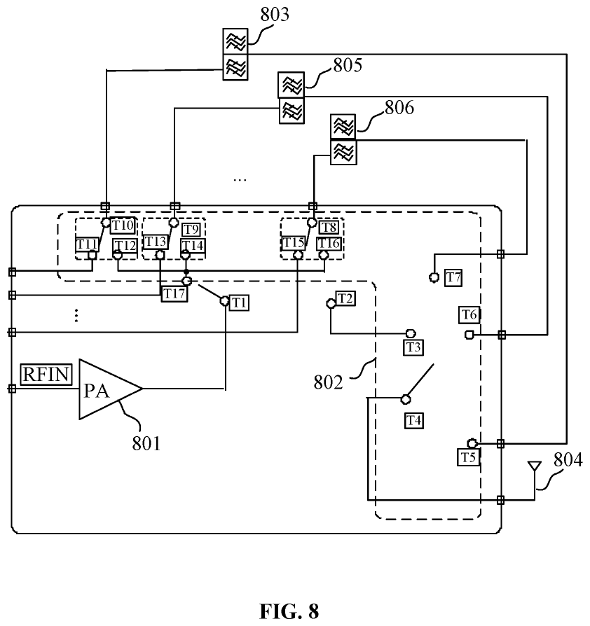

FIG. 8 is a schematic diagram showing a composition structure of a radio frequency front-end module according to an embodiment of the disclosure. In FIG. 8, a connection of the radio frequency module and an antenna 704 is also shown. In the composition structure of the radio frequency front-end module according to the embodiment shown in FIG. 8, the first filter 703 is replaced with a first duplexer 803, the second filter 705 is replaced with a second duplexer 805, and the third filter 706 is replaced with a third duplexer 806. As shown in FIG. 8, in a case that the filter is replaced with the duplexer, a reception filter at the upper end of the duplexer receives a radio frequency signal sent by the antenna which is to be filtered.

The radio frequency signal includes, but is not limited to, 2G, 3G, 4G, and 5G signals.

In some implementations, at least one duplexer or multiplexer can be used to replace one filter in the embodiment to avoid signal interference, and thus the function and processing of the components in the embodiment are not described again.

The processing on a radio frequency signal transferred in the radio frequency front-end module is controlled by switching a connection of the switch in the embodiment of the disclosure, thereby overcoming the defect in the related art that an amplifier is added corresponding to the type of the radio frequency signal, effectively reducing the area of the radio frequency front-end module, and simplifying a connection relationship between the components in the radio frequency front-end module. Moreover, in the embodiment of the disclosure, an application environment is not defined, and it is simple and convenient to implement, and an application range is wide.

Various embodiments of the disclosure can have one or more of the following advantages.

For example, a radio frequency front-end module provided according to the embodiment of the disclosure includes: an amplifier, a switch and a filter. The switch is configured to, in a case that a radio frequency signal is to be transmitted and the radio frequency signal transferred from a baseband chip is to be filtered by the radio frequency front-end module, connect the amplifier with an antenna, and connect the amplifier with the filter, so as to form a first signal path in the radio frequency front-end module for amplifying and filtering the radio frequency signal transferred in the first signal path. The switch is further configured to, in a case that the transferred radio frequency signal is not to be filtered by the radio frequency front-end module, connect the amplifier with the antenna, so as to form a second signal path in the radio frequency front-end module for amplifying the radio frequency signal transferred in the second signal path. A method for processing a radio frequency signal is further provided in the disclosure. In the embodiments of the disclosure, a radio frequency signal received or transmitted is processed by a radio frequency front-end module. In this way, as compared with the related art, an application environment is not defined, and it is simple and convenient to implement, and an application range is wide. Since the number of amplifiers is reduced, the area and volume of the radio frequency front-end terminal can be effectively reduced while reducing manufacture cost.

The foregoing is only the preferred embodiment of the disclosure and is not intended to limit the protection scope of disclosure. Any modifications, equivalent substitutions, improvements and the like made within the spirit and principle of the disclosure shall fall within the protection scope of the disclosure.

1. A radio frequency front-end module, comprising:
an amplifier, a switch and a filter, wherein
the switch is configured to, in a case that a radio frequency signal is to be transmitted and the radio frequency signal transferred from a baseband chip is to be filtered by the radio frequency front-end module, couple the amplifier with an antenna, and couple the amplifier with the filter, so as to form a first signal path in the radio frequency front-end module, wherein the first signal path is configured to amplify and filter the radio frequency signal transferred in the first signal path; and
the switch is further configured to, in a case that the transferred radio frequency signal is not to be filtered by the radio frequency front-end module, couple the amplifier with the antenna, so as to form a second signal path in the radio frequency front-end module, wherein the second signal path is configured to amplify the radio frequency signal transferred in the second signal path.

2. The radio frequency front-end module according to claim 1, wherein
the amplifier in the first signal path is configured to: in a case that a radio frequency signal is to be transmitted, amplify the radio frequency signal; and send the amplified to-be-transmitted radio frequency signal to the filter in the first signal path;
the filter in the first signal path is configured to: filter the amplified to-be-transmitted radio frequency signal; send the filtered to-be-transmitted radio frequency signal to the antenna; and transmit the to-be-transmitted radio frequency signal through the antenna; and
the amplifier in the second signal path is configured to: in a case that a radio frequency signal is to be transmitted, amplify the radio frequency signal; and send the amplified to-be-transmitted radio frequency signal to the antenna in the second signal path.

3. The radio frequency front-end module according to claim 2, wherein
the number of filters is at least two,
the switch is further configured to switch a connection state, to connect at least one filter in the at least two filters with the amplifier, and connect the amplifier with the antenna, so as to form the first signal path corresponding to the at least one filter; and
the at least one filter is further configured to filter a to-be-transmitted radio frequency signal in a frequency band corresponding to the at least one filter in the first signal path corresponding to the at least one filter.

4. The radio frequency front-end module according to claim 1, wherein
the switch is further configured to, in a case that a radio frequency signal sensed by the antenna is to be received, connect the antenna with the filter, and connect a baseband chip, so as to form a third signal path in the radio frequency front-end module for filtering the received radio frequency signal transferred in the third signal path; and
the switch is further configured to, in a case that a radio frequency signal sensed by the antenna is to be received, connect the antenna with the baseband chip, so as to form a fourth signal path in the radio frequency front-end module for transferring the received radio frequency signal in the fourth signal path.

5. The radio frequency front-end module according to claim 4, wherein
the number of filters is at least two;
the switch is further configured to switch a connection state, to connect at least one filter in the at least two filters with the antenna, so as to form the third signal path corresponding to the at least one filter; and
the at least one filter is further configured to filter a received radio frequency signal in a frequency band corresponding to the at least one filter in the third signal path corresponding to the at least one filter.

6. A method for processing a radio frequency signal, comprising:
in a case that a to-be-transmitted radio frequency signal transferred is to be filtered by a radio frequency front-end module, connecting an amplifier with an antenna through a switch, and connecting the amplifier with a filter through the switch, so as to form a first signal path in the radio frequency front-end module, and amplifying and filtering the to-be-transmitted radio frequency signal transferred based on the first signal path; and
in a case that the transferred radio frequency signal is not to be filtered by the radio frequency front-end module, connecting the amplifier with the antenna through the switch, so as to form a second signal path in the radio frequency front-end module, and amplifying the to-be-transmitted radio frequency signal transferred based on the second signal path.

7. The method according to claim 6, wherein
the amplifying and filtering the radio frequency signal transferred based on the first signal path comprises:
amplifying, by the amplifier in the first signal path, the to-be-transmitted radio frequency signal, and sending the amplified to-be-transmitted radio frequency signal to the filter in the first signal path; and
filtering, by the filter in the first signal path, the amplified to-be-transmitted radio frequency signal, sending the filtered to-be-transmitted radio frequency signal to the antenna, and transmitting the to-be-transmitted radio frequency signal through the antenna, and
the amplifying the radio frequency signal transferred based on the second signal path comprises:
amplifying, by the amplifier in the second signal path, the to-be-transmitted radio frequency signal, sending the amplified to-be-transmitted radio frequency signal to the antenna, and transmitting the to-be-transmitted radio frequency signal through the antenna.

8. The method according to claim 6, further comprising:
switching a connection state of the switch in a case that the number of filters is at least two, to connect at least one filter in the at least two filters with the amplifier, and connect the amplifier with the antenna, so as to form the first signal path corresponding to the at least one filter; and
filtering a to-be-transmitted radio frequency signal in a frequency band corresponding to the at least one filter in the first signal path corresponding to the at least one filter.

9. The method according to claim 6, further comprising:
in a case that a received radio frequency signal sensed by the antenna is to be filtered, connecting the antenna with the filter through the switch, and connecting a baseband chip through the switch, so as to form a third signal path in the radio frequency front-end module, and filtering the received radio frequency signal transferred in the third signal path based on the third signal path; and
in a case that a received radio frequency signal sensed by the antenna is not to be filtered, connecting the antenna with the baseband chip through the switch, so as to form a fourth signal path in the radio frequency front-end module, and transferring the received radio frequency signal based on the fourth signal path.

10. The method according to claim 9, further comprising:
switching a connection state of the switch in a case that the number of filters is at least two, to connect at least one filter in the at least two filters with the antenna, so as to form the third signal path corresponding to the at least one filter; and
filtering a received radio frequency signal in a frequency band corresponding to the at least one filter in the third signal path corresponding to the at least one filter.

11. A mobile communication apparatus comprising the radio frequency front-end module according to claim 1, further comprising the antenna configured to receive and transmit 2G, 3G, 4G, and 5G radio frequency signals; wherein the filter includes a first flute and a second filter respectively configured to filter, in respective frequency bands, to-be-transmitted radio frequency signals to be filtered.

12. The apparatus according to claim 11, wherein a first end of the amplifier is connected to a first connection end of the switch; a second connection end of the switch is connected to a third connection end of the switch; a fourth connection end of the switch is connected to a first end of the antenna; a first end of the first filter is connected to a fifth connection end of the switch, and a second end of the first filter is connected to a sixth connection end of the switch; a first end of the second filter is connected to a seventh connection end of the switch, and a second end of the second filter is connected to an eighth connection end of the switch.

13. The apparatus according to claim 12, wherein the amplifier in the second signal path is configured to: amplify the to-be-transmitted radio frequency signal, send the amplified to-be-transmitted radio frequency signal to the antenna, and transmit the to-be-transmitted radio frequency signal through the antenna; in a case that the to-be-transmitted radio frequency signal is not to be filtered, the amplifier in the second signal path is configured to: amplify the to-be-transmitted radio frequency signal, send the amplified to-be-transmitted radio frequency signal to the antenna, and transmit the to-be-transmitted radio frequency signal through the antenna.

14. The apparatus according to claim 11, wherein a first end of the amplifier is connected to a first connection end of the switch; a second connection end of the switch is connected to a third connection end of the switch; a fourth connection end of the switch is connected to a first end of the antenna; the switch includes a first sub-switch and a second sub-switch; a first end of the first sub-switch is connected to the first end of the amplifier, and a first end of the second sub-switch is connected to the first end of the antenna; the first sub-switch is configured to, in a case that the transferred radio frequency signal is to be filtered by the radio frequency front-end module, connect a second end of the first sub-switch with the first end of the filter corresponding to the target communication frequency band; the second sub-switch is configured to, in a case that the transferred radio frequency signal is to be filtered by the radio frequency front-end module, connect a second end of the second sub-switch with the second end of the filter corresponding to the target communication frequency band, so as to form the first signal path corresponding to the target communication frequency band in the radio frequency front-end module; the first sub-switch is configured to, in a case that the transferred radio frequency signal is not to be filtered by the radio frequency front-end module, connect a second end of the first sub-switch with a second end of the second sub-switch, so as to form the second signal path for directly connecting the amplifier with the antenna in the radio frequency front-end module.

15. The apparatus according to claim 14, wherein a connection relationship between the first sub-switch and the second sub-switch is changeable in response to a control instruction transmitted by a controller to the switch; the control instruction includes to a high-level signal and a low-level signal.

16. The apparatus according to claim 15, wherein the controller is provided inside the radio frequency front-end module, or implemented by a baseband chip in a base station or a terminal.

17. The apparatus according to claim 11, wherein the filter includes a first filter, a second filter, and a third filter respectively configured to filter, in respective frequency bands, radio frequency signals which are to be filtered; the switch is configured to, in a case that a transferred radio frequency signal is to be filtered, connect the amplifier with the antenna, and connect the amplifier with the first filter or connect the amplifier with the second filter or connect the amplifier with the third filter, so as to form a first signal path in the radio frequency front-end module.

18. The apparatus according to claim 17, wherein a first end of the amplifier is connected to a first connection end of the switch; a second connection end of the switch is connected to a third connection end of the switch; a fourth connection end of the switch is connected to a first end of the antenna; a first end of the first filter is connected to a fifth connection end of the switch; a second end of the first filter is connected to a sixth connection end of the switch; a first end of the second filter is connected to a seventh connection end of the switch; a second end of the second filter is connected to an eighth connection end of the switch; a first end of the third filter is connected to a ninth connection end of the switch; a second end of the third filter is connected to a tenth connection end of the switch.

19. The apparatus according to claim 17, wherein the switch is configured to, in a case that a radio frequency signal received by the antenna is to be filtered, connect the first filter with a baseband chip or connect the second filter with the baseband chip or connect the third filter with the baseband chip, so as to form a third signal path in the radio frequency front-end module; wherein the third signal path is configured to filter the 2G, 3G or 4G signal received by the antenna, and send the filtered radio frequency signal to the baseband chip; where the switch is further configured to, in a case that the 2G, 3G or 4G signal received by the antenna is not to be filtered, connect the baseband chip with the antenna, so as to form a fourth signal path in the radio frequency front-end module; the fourth signal path is configured to transmit the radio frequency signal received by the antenna to the baseband chip; the first filter in the third signal path is configured to: filter a radio frequency signal received by the antenna which is to be filtered, where the radio frequency signal includes 2G signals in different frequencies; send the filtered radio frequency signal to the baseband chip.

20. The apparatus according to claim 19, wherein the second filter in the third signal path is configured to: filter a radio frequency signal received by the antenna which is to be filtered, where the radio frequency signal includes 3G signals in different frequencies; send the filtered radio frequency signal to the baseband chip; the third filter in the third signal path is configured to: filter a radio frequency signal received by the antenna which is to be filtered, where the radio frequency signal includes 4G signals in different frequencies; send the filtered radio frequency signal to the baseband chip; the baseband chip is connected to a first connection end of the switch; a second connection end of the switch is connected to a third connection end of the switch; a fourth connection end of the switch is connected to a first end of the antenna; a first end of the first filter is connected to a tenth connection end of the switch, and a second end of the first filter is connected to a fifth connection end of the switch; a first end of the second filter is connected to a ninth connection end of the switch, and a second end of the second filter is connected to a sixth connection end of the switch; a first end of the third filter is connected to an eighth connection end of the switch, and a second end of the third filter is connected to a seventh connection end of the switch.
